(19) United States
(12) Patent Application Publication
(10) Pub. No.: US 2024/0341246 A1
(43) Pub. Date: Oct. 17, 2024

(54) IRRIGATION SYSTEMS, METHODS, AND APPARATUS

(71) Applicant: Superior Industries, Inc., Morris, MN (US)

(72) Inventors: Paulo Batagini, Rafard (BR); Augusto Costa, Rafard (BR); Vinicius Jaime, Rafard (BR); Gustavo Hossri, Valinhos (BR)

(21) Appl. No.: 18/638,318

(22) Filed: Apr. 17, 2024

Related U.S. Application Data
(60) Provisional application No. 63/496,593, filed on Apr. 17, 2023.

(51) Int. Cl. A01G 25/02; F16L 33/02

(52) U.S. Cl. CPC A01G 25/02; F16L 33/02

(57) ABSTRACT

Irrigators systems, methods and apparatus are provided for supporting a hose. In some embodiments the hose is at least partly supported on a hose holder and the hose holder is supported on a transversely extending support. In some embodiments the transversely extending support is supported on a clamp assembly configured to be mounted to a pipe of an irrigator system.

### BACKGROUND

Irrigation systems, methods, and apparatus are used to apply water and other crop inputs to soil, crops, plants, etc.

### BRIEF DESCRIPTION OF THE DRAWINGS

FIG. 1 is a perspective view of part of an embodiment of an irrigator including a embodiment of a row assembly.

FIG. 2 is an expanded perspective view of a portion of FIG. 1.

FIG. 3 is a further expanded perspective view of a portion of FIG. 1.

FIG. 4 is a perspective view of a portion of the row assembly of FIG. 1.

FIG. 5 is a side view of a portion of the row assembly of FIG. 1.

### DESCRIPTION

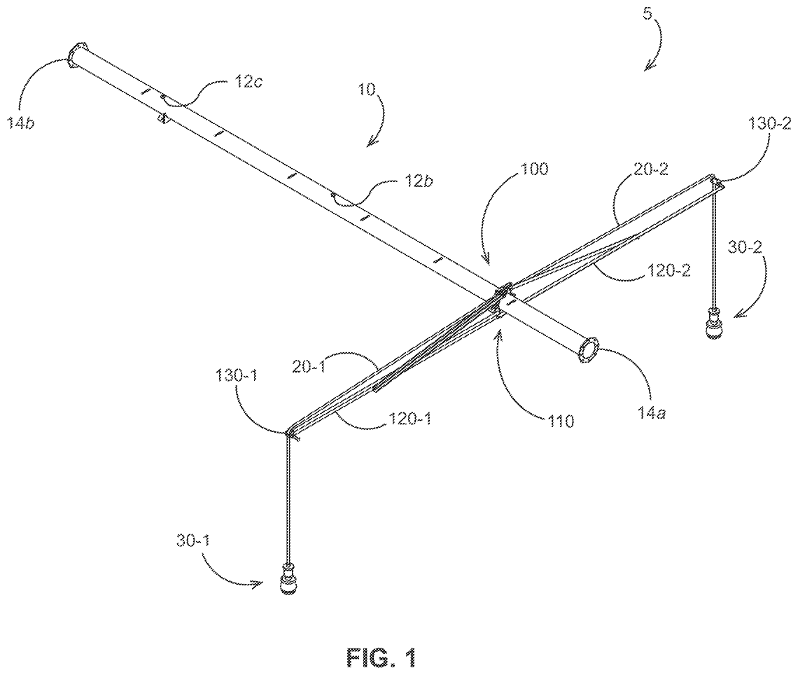

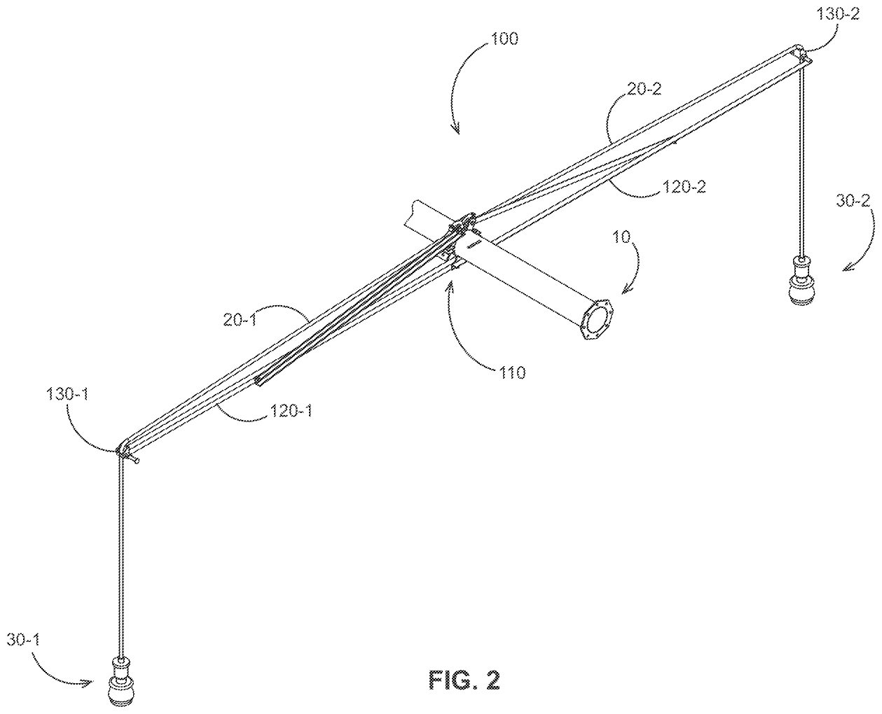

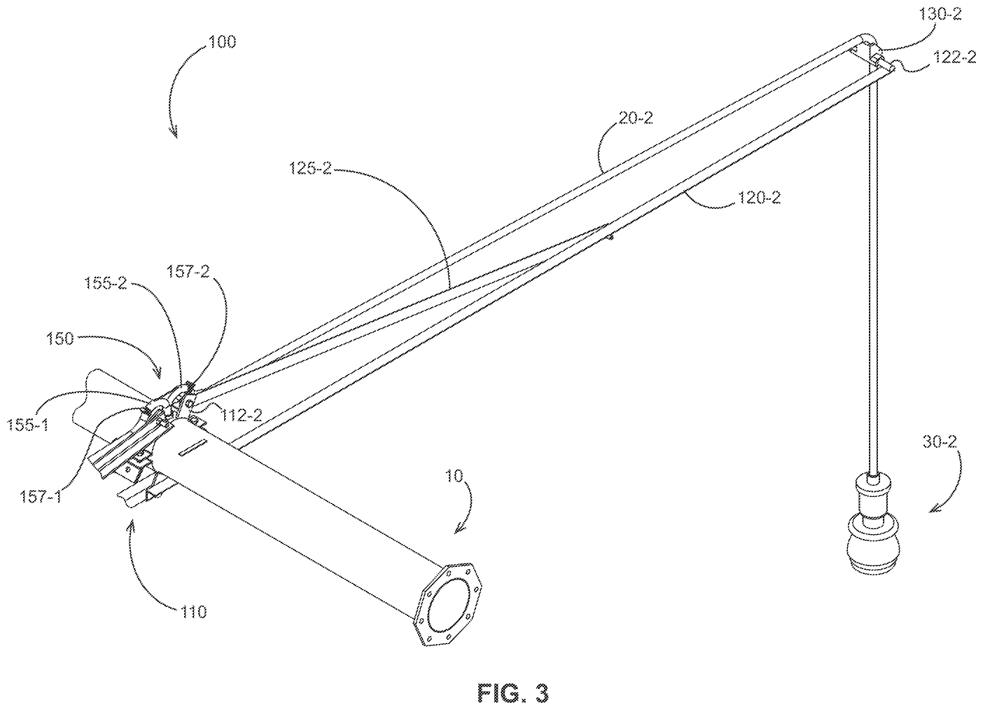

Referring to the drawings, wherein like reference numerals designate identical or corresponding parts throughout the several views, FIGS. 1-3 illustrate an embodiment of an irrigator 5 including a pipe 10 fluidly coupled to a water supply system (not shown) by flanges 14a and 14b. In some embodiments, pipe 10 is of a standard outer diameter (e.g., standard irrigation pipe diameter, standard PVC pipe diameter, standard diameter of pipes of other materials, etc.) The pipe 10 includes one or more outlets 12 (e.g., 12c, 12b, and 12a which is not visible in FIG. 1 as described below). The irrigator 5 optionally comprises one or more row assemblies 100 which extend transversely (e.g., perpendicular) to the pipe 10. Each row assembly 100 supports one or more valves 30 (e.g., sprinkler valves, spray valves, drip valves, etc.) such as a valve 30-1 and a valve 30-2. In some embodiments the length of hose 20 (e.g., an outboard portion thereof, a vertically extending portion thereof, etc.) or other suitable conduit is selected to support the associated valve 30 near a ground surface (e.g., the hose 20 optionally extends downward approximately the height of the pipe 10 relative to the ground in some embodiments). The row assembly 100 optionally supports one or more flexible hoses 20 (e.g., 20-1, 20-2) such as hoses, which fluidly couple the outlet 12 to one or more valves 30 (e.g., valves 30-1, 30-2 respectively). Referring to FIG. 3, in some embodiments each flexible hose 20 is fluidly coupled to an outlet 12 by a coupler 150 (e.g., multiple-outlet fluid coupler such as a tee fitting, single-outlet fluid coupler, etc.). In some embodiments a hose 20-1 is coupled to an outlet 155-1 of coupler 150 (e.g., by a removable securing device 157-1 such as a hose clamp). In some embodiments a hose 20-2 is coupled to an outlet 155-2 of coupler 150 (e.g., by a removable securing device 157-2 such as hose clamp).

The row assembly 100 optionally comprises at least one hose support or hose support bracket 120 (e.g., support bracket 120-1 and support bracket 120-2) transversely extending from the pipe 10. Each support bracket 120 is optionally supported by an angle bracket 125 (e.g., 125-1, 125-2 respectively) at a proximal end thereof. Each support bracket 120 optionally supports a hose support 130 (e.g., support brackets 120-1, 120-2 optionally support hose supports 130-1, 130-2 respectively) at a distal end thereof. In some embodiments each hose support is optionally at least partially made of plastic material and each angle bracket and/or support bracket is optionally made of metal. The hose support 130 optionally comprises a releasable clamp, resilient clip, releasable clip, tic, hose clamp, or other structure suitable to at least partly secure (e.g., resiliently secure, releasably secure, removably secure) at least a portion of the hose 20. The hose support 130 is optionally mounted to a pin 122 or other support structure which may be mounted (e.g., at or near a distal end thereof) to the support bracket 120. The hose 20 optionally approaches the hose support 130 in a direction that is generally horizontal or at an acute angle below horizontal. The hose 20 optionally extends away from the hose support 130 in a downward direction. The hose support 130 optionally supports a portion of the hose 20 (e.g., a distal portion thereof) in a generally vertical orientation. In some embodiments, the hose support 130 does not positively grasp or clamp the hose 20 but rather simply prevents the hose 20 from sliding off of the hose support 130 (e.g., during operation).

Each hose support bracket 120 optionally supports includes structure mounted (e.g., removably mounted) to the pipe 10 that supports each support bracket and each angle bracket. In some embodiments, this structure comprises a clamp assembly 110. Clamp assembly is optionally configured to releasably clamp a pipe having at least one of a set of standard pipe diameters.

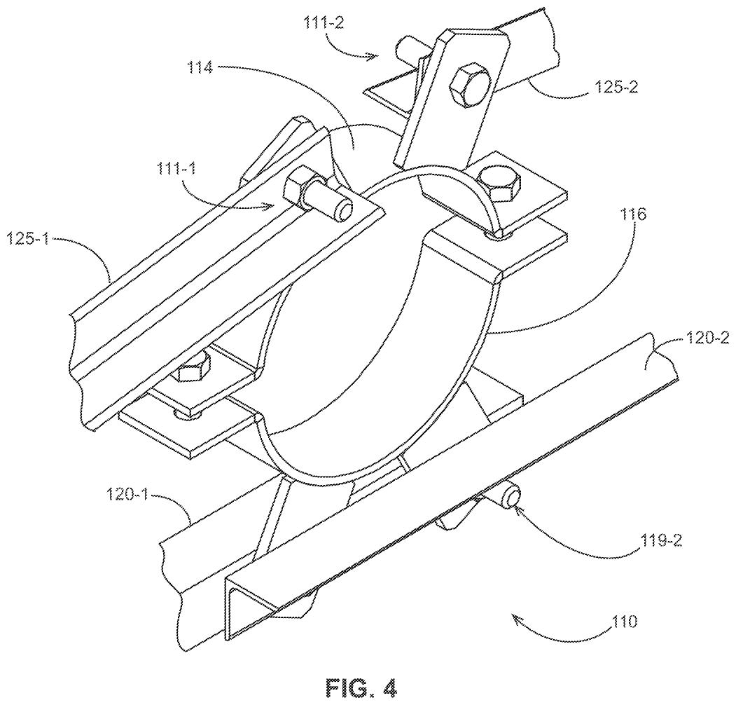

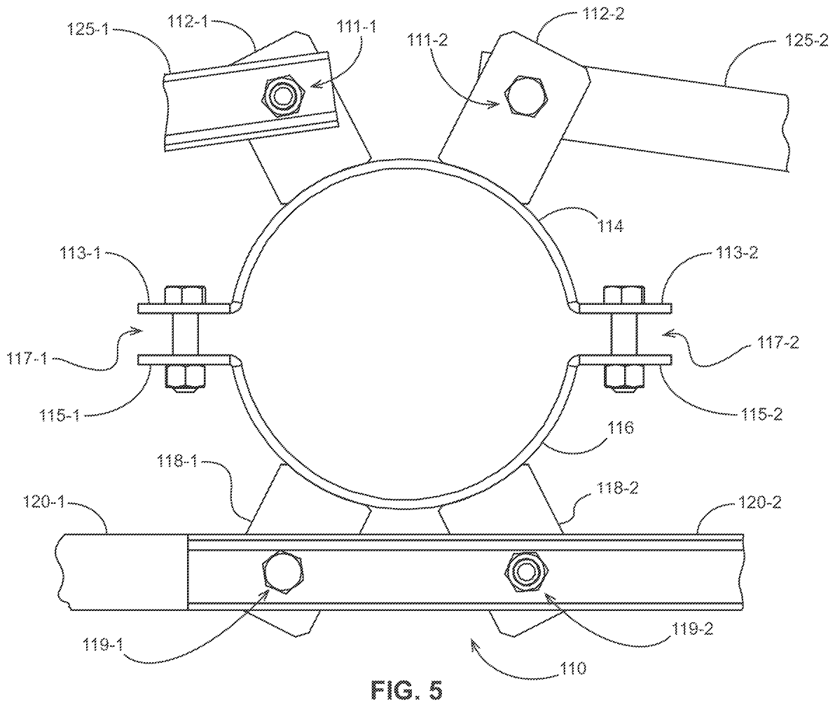

Referring to FIGS. 3 through 5, the row assembly 100 optionally comprises a first clamp portion 114 and a second clamp portion 116. Each clamp portion optionally includes an inner mating surface (e.g., arcuate surface such as a semi-circular surface) configured to mate to the pipe 10. Clamp portion 114 optionally comprises lips 113-1, 113-2. Clamp portion 116 optionally comprises lips 115-1, 115-2. The lips 113-1 and 115-1 are optionally removably securable together such as by a fastener assembly 117-1 (e.g., nut and bolt assembly). The lips 113-2 and 115-2 are optionally removably securable together such as by a fastener assembly 117-2 (e.g., nut and bolt assembly). During installation of the clamp assembly 110 onto pipe 10, tightening of fastener assemblies 117-1, 117-2 optionally secures each clamp portion 114, 116 to the pipe 10 and optionally to the other clamp portion.

Continuing to refer to FIGS. 3-5, the clamp assembly 110 optionally includes first and second angle bracket supports 112-1, 112-2 (e.g., angles, lips, mounting cars, etc.) which are optionally mounted to the clamp portion 114 (e.g., by welding) and optionally extend generally away from the pipe 10 when the clamp assembly 110 is installed on pipe 10. The angle bracket supports 112-1, 112-2 are optionally mounted to angle brackets 125-1, 125-2, respectively such as by fastener assemblies 111-1, 111-2, respectively.

Continuing to refer to FIGS. 3-5, the clamp assembly 110 optionally includes first and second bracket supports 118-1, 118-2 (e.g., angles, lips, mounting cars, etc.) which are optionally mounted to the clamp portion 116 (e.g., by welding) and optionally extend generally away from the pipe 10 when the clamp assembly 110 is installed on pipe 10. The angle bracket supports 118-1, 118-2 are optionally mounted (e.g., removably mounted, releasably mounted) to support brackets 120-1, 120-2, respectively such as by fastener assemblies 119-1, 119-2, respectively.

Reference numerals recited with the suffixes -1 and -2 indicate that the objects of the reference numerals comprise a corresponding (e.g., structurally similar, structurally identical, identical, symmetrical, similar, functionally similar, functionally identical, etc.) pair. In any instance where a reference numeral is shown with one of the suffixes -1 or -2 and the reference numeral with the other suffix is omitted from the drawings and/or the written description, it is hereby positively recited that there is at least one embodiment including the omitted corresponding object.

It should be appreciated that alternative embodiments of assemblies 100 and/or assemblies 110 may be configured to extend to a single side of pipe 10 rather than both sides.

Reference numerals recited with sequential letter suffixes (e.g., a, b, c, etc.) indicate that the objects of the reference numerals comprise a series of corresponding (e.g., structurally similar, structurally identical, identical, similar, functionally similar, functionally identical, etc.) objects. In any instance where a letter suffix (e.g., c) is used and one or more of the preceding letter suffixes (e.g., a, b) are omitted from the drawings and/or the written description, it is hereby positively recited that there is at least one embodiment including the omitted corresponding objects in the series.

Any ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A row assembly configured to be supported on a pipe of an irrigator, the pipe having an outlet, the row assembly comprising:
a clamp assembly configured to be removably mounted to the pipe;
a transversely extending first support having a proximal end and a distal end, said proximal end being attached to said clamp assembly; and
a first hose support supported closer to said distal end than said proximal end of said first support, said first hose support configured to at least partly support at least a portion of a first hose.

2. The row assembly of claim 1, further comprising:
a fitting configured to be fluidly coupled to the outlet;
a first hose having a proximal end, an intermediate portion and a distal end, said first hose being fluidly coupled to said fitting at said proximal end, said first hose being at least partly supported at said intermediate portion on said first hose support; and
a valve, said valve being at least partly supported on said distal end of said first hose.

3. The row assembly of claim 1, further comprising:
a transversely extending second support having a proximal end and a distal end, said proximal end being attached to said clamp assembly; and
a second hose support supported closer to said distal end than said proximal end of said second support, said second hose support configured to at least partly support at least a portion of a second hose.

4. An irrigator, comprising:
a pipe having an outlet; and
a row assembly removably supported on said pipe, said row assembly comprising:
a clamp assembly configured to be removably mounted to the pipe;
a transversely extending first support having a proximal end and a distal end, said proximal end being attached to said clamp assembly; and
a first hose support supported closer to said distal end than said proximal end of said first support, said first hose support configured to at least partly support at least a portion of a hose.

5. The irrigator of claim 4, wherein the row assembly further comprises:
a fitting fluidly coupled to said outlet;
a first hose having a proximal end, an intermediate portion and a distal end, said first hose being fluidly coupled to said fitting at said proximal end, said first hose being at least partly supported at said intermediate portion on said first hose support; and
a valve, said valve being at least partly supported on said distal end of said first hose.

6. The irrigator of claim 4, wherein the row assembly further comprises:
a transversely extending second support having a proximal end and a distal end, said proximal end being attached to said clamp assembly; and
a second hose support supported closer to said distal end than said proximal end of said second support, said second hose support configured to at least partly support at least a portion of a hose.

7. A row assembly configured to be supported on a pipe of an irrigator, the pipe having an outlet, the row assembly comprising:
a clamp assembly configured to be removably mounted to the pipe;
a transversely extending first support having a proximal end and a distal end, said proximal end being attached to said clamp assembly;
a first hose support, said first hose support configured to at least partly support at least a portion of a hose; and
a fitting configured to be fluidly coupled to the outlet; and
a first hose having a proximal end, an intermediate portion and a distal end, said first hose being fluidly coupled to said fitting at said proximal end, said first hose being at least partly supported at said intermediate portion on said first hose support; and
a valve, said valve being disposed at said distal end of said first hose.

8. The row assembly of claim 7, further comprising:
a transversely extending second support having a proximal end and a distal end, said proximal end being attached to said clamp assembly; and
a second hose support supported closer to said distal end than said proximal end of said second support, said second hose support configured to at least partly support at least a portion of a hose.

9. The row assembly of claim 7, further comprising:
a transversely extending second support having a proximal end and a distal end, said proximal end being attached to said clamp assembly; and
a second hose support supported closer to said distal end than said proximal end of said second support, said second hose support configured to at least partly support at least a portion of a second hose.

10. The row assembly of claim 7, wherein said first hose support is at least partially made of a plastic material, and wherein said first support is at least partially made of metal.

11. The row assembly of claim 7, wherein said first hose support is configured to releasably secure a portion of said hose.

12. The row assembly of claim 11, wherein said first hose support comprises a releasable clamp.

13. The row assembly of claim 7, further comprising:
a first pin mounted to said first support at a distal end of said first support, wherein said first hose support is mounted to said first pin.

14. The row assembly of claim 7, wherein said first hose approaches said first hose support along a direction that is at or below horizontal.

15. The row assembly of claim 7, wherein said first hose approaches said first hose support in a direction along an acute angle below horizontal.

16. The row assembly of claim 15, wherein said first hose approaches extends away from said hose support in a downward direction.

17. The row assembly of claim 7, wherein said first hose approaches extends away from said hose support in a downward direction.

18. The row assembly of claim 7, wherein said first hose support does not positively clamp said first hose.

19. The row assembly of claim 7, wherein said first hose support positively clamps said first hose.

20. The row assembly of claim 7, wherein said first support comprises a bracket.
